(19) United States
(12) Patent Application Publication
(10) Pub. No.: US 2006/0206379 A1
(43) Pub. Date: Sep. 14, 2006

(54) Methods and apparatus for improving the matching of relevant advertisements with particular users over the internet

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/299,096

(22) Filed: Dec. 9, 2005

Related U.S. Application Data
(60) Provisional application No. 60/661,761, filed on Mar. 14, 2005.

(51) Int. Cl. G06Q 30/00

(52) U.S. Cl. 705/14

(57) ABSTRACT

A method of matching an advertisement to a user engaging an interface includes identifying a plurality of advertisements; obtaining a source ambient factor, wherein the source ambient factor describes a variable condition of at least one of the user's environment and the user's body; and selecting an advertisement from the plurality of identified advertisements to be displayed to the user via an interface, the selected advertisement having a predetermined relational association with the obtained source ambient factor.

This application claims the benefit of U.S. Provisional Application No. 60/661,761 filed Mar. 14, 2005, which is incorporated in its entirety herein by reference.

### BACKGROUND OF THE INVENTION

1. Field of the Invention

The present invention relates generally to advertising and, more particularly, to serving computer-selected advertisements over the internet or similar communication networks to computer users with improved targeting accuracy.

2. Discussion of the Related Art

Advertising using traditional media, such as television, radio, newspapers and magazines, is well known. Advertisers have used these types of media to reach a large audience with their advertisements (“ads”). To reach a more responsive audience, advertisers have used demographic studies. For example, advertisers may use broadcast events such as football games to advertise beer and action movies to a younger male audience. However, even with demographic studies and entirely reasonable assumptions about the typical audience of various media outlets, advertisers recognize that much of their ad budget is simply wasted because the target audience is not interested in the ad they are receiving.

Interactive media, such as the Internet, has the potential for better targeting of advertisements. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. An example of such a system is the Adwords system offered by Google, Inc.

While systems such as Adwords have provided advertisers the ability to better target ads, their effectiveness is limited to sites where a user enters a search query to indicate their topic of interest. Most web pages, however, do not offer search functionality and for these pages it is difficult for advertisers to target their ads. As a result, often, the ads on non-searched pages are of little value to the viewer of the page and are therefore viewed more as an annoyance than a source of useful information. Not surprisingly, these ads typically provide the advertiser with a lower return on investment than search-based ads, which are more targeted.

To increase the targeting accuracy of ads, methods have been developed for providing relevant ads for situations where a document is provided to an end user, but not necessarily in response to an express indication of a topic of interest by the end user (e.g., not responsive to the end user submitting a search query). For example, US Patent Application Publication No. 2004/0059708, which is hereby incorporated by reference, can be understood to disclose a method wherein the content of a web page is analyzed to determine a list of one or more topics associated with that web page. An advertisement is considered to be relevant to that web page if it is associated with keywords belonging to the list of one or more topics. One or more of these relevant advertisements may be displayed to a user in conjunction with that web page or related web pages. Even with the above-described method, there is still a need for increasing the targeting accuracy of advertisements because, while current methods account for the content of a document and/or documents that a user may be accessing, current methods do not account for important factors (i.e., herein referred to as “ambient factors”) within the user's then-current environment that may affect his or her then-current state-of-mind and, therefore, influence his or her receptivity to a particular advertisement. Accordingly, it would be beneficial to provide a method and system for improving the accuracy with which advertisements are targeted to a user based on ambient factors specific to the user.

### SUMMARY OF THE INVENTION

Several embodiments of the invention advantageously address the needs above as well as other needs by providing a method and apparatus for improving the matching of advertisements with particular users over the internet.

In one embodiment, the invention can be characterized as a method of matching an advertisement to a user engaging a computer interface that includes identifying a plurality of advertisements having a predetermined relevance to the user based at least in part upon at least one of a search query entered by the user and the contents of a target document viewed by the user; obtaining at least one source ambient factor for the user, wherein the source ambient factor describes at least one of a current variable environmental condition and a current variable bodily condition of the user that affects the user's current, state-of-mind; selecting one of the plurality of identified advertisements based at least in part upon at least one source ambient factor obtained for the user and at least one predetermined relational association between a target ambient factor and the selected one of the plurality of identified advertisements; and displaying the selected advertisement to the user and not displaying the other of the plurality of advertisements.

In another embodiment, the invention can be characterized as a method of matching an advertisement to a user engaging an interface that includes identifying a plurality of advertisements; obtaining a source ambient factor, wherein the source ambient factor describes a variable condition of at least one of the user's environment and the user's body; and selecting an advertisement from the plurality of identified advertisements to be displayed to the user via an interface, the selected advertisement having a predetermined relational association with the obtained source ambient factor.

In still another embodiment, the invention can be characterized as an apparatus for matching an advertisement to a user engaging an interface that includes means for identifying a plurality of advertisements; means for obtaining a source ambient factor, wherein the source ambient factor describes a variable condition of at least one of the user's environment and the user's body; and means for selecting an advertisement from the plurality of identified advertisements to be displayed to the user via an interface, the selected advertisement having a predetermined relational association with the obtained source ambient factor.

In a further embodiment, the invention may be characterized as an apparatus for matching an advertisement to a user engaging an interface that includes circuitry having executable instructions; and at least one processor configured to execute the program instructions to perform operations of: identifying a plurality of advertisements; obtaining a source ambient factor, wherein the source ambient factor describes a variable condition of at least one of the user's environment and the user's body; and selecting an advertisement from the plurality of identified advertisements to be displayed to the user via an interface, the selected advertisement having a predetermined relational association with the obtained source ambient factor.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram illustrating an environment within which the invention may be implemented;

FIG. 2 is a diagram functionally illustrating an advertising system consistent with the invention;

FIG. 3 is a diagram illustrating apparatus with which the invention may be implemented;

FIG. 4 is a flow diagram of an exemplary method for providing relevant advertisements, consistent with the present invention; and

FIG. 5 is a sample target document.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

In accordance with many embodiments of the present invention, methods and apparatus are disclosed herein that improve the matching of relevant advertisements (e.g., web-served advertisements) with appropriate users (e.g., web users) by taking into account one or more current ambient factors that may impact a user's current state-of-mind, resulting in an increased likelihood that a particular user will be more receptive to, and/or respond more positively to an automatically selected advertisement that is displayed to him or her at that time.

In many embodiments, ambient factors used in improving matching of relevant advertisements to users can be divided into two exemplary classes of ambient factors: environmental ambient factors and bodily ambient factors. Environmental ambient factors describe variable conditions within a user's local environment that impact, reflect, and/or predict a user's state-of-mind. Bodily ambient factors describe variable conditions of the user's body that impact, reflect, and/or predict a user's state-of-mind. Accordingly, ambient factors generally describe variable conditions specific to a user (e.g., a user's local environment and/or a user's body) that impact, reflect, or otherwise predict a user's receptivity to automatically selected advertisements that are displayed to him or her.

As used herein, the phrase “user's local environment,” “user's environment,” or “local environment” generally refers to a physical space or area surrounding the user and that can be characterized as having conditions which are likely to significantly or directly influence the user's state-of-mind and/or be indicative of the user's state-of-mind. Moreover, the actual physical space or area to which a “user's local environment,” (or “user's environment,” or “local environment”) refers is contextual in that it varies with respect to the particular environmental ambient factor. For example, the phrase “user's local environment” can refer to an indoor space (e.g., a room of a house in which a user is located), an outdoor space (e.g., the outside space immediately surrounding the user's house), a zip-code, a city, a state, a geographic region, a time-zone, etc., depending on the type of environmental ambient factor that describes a condition within that space.

Environmental ambient factors used in improving matching of relevant advertisements to users can be divided into the following exemplary, non-exhaustive, list of sub-classes of environmental ambient factors: weather condition, the location of the sun in the sky, the location of the moon in the sky, time of day (e.g., based upon the time zone local to the user's environment), day of the week (e.g., based upon the time zone local to the user's environment), ambient sound levels, ambient characteristic sounds, ambient light levels, ambient characteristic images, and the like, or combinations thereof. Further, bodily ambient factors used in improving matching of relevant advertisements to users can be divided into the following exemplary, non-exhaustive, list of sub-classes of bodily ambient factors: body temperature, blood pressure, body posture (e.g., whether a user is standing, sitting, reclining, etc.), heart rate, and the like, or combinations thereof. Each of the ambient factors exemplarily listed above can be characterized by values (i.e., ambient factor values) of ambient factor data such as weather data, sun data, moon data, time data, date data, etc.

As described above, each ambient factor describes a particular variable condition specific to either the user's environment and/or body. For example, the ambient factor “time of day” may indicate, with some degree of resolution, the current time of day; the ambient factor “day of week” may indicate, with some degree of resolution, the current day of the week (e.g., whether it is currently the weekend within the user's environment); the ambient factor “weather conditions” may indicate the current weather within the user's environment (e.g., whether it is currently raining, whether it is currently hot, whether it is currently snowing, etc.); the ambient factor “ambient sound level” may indicate whether it is noisy or quiet within the user's environment; the ambient factor “ambient characteristic sound” may indicate, based on captured sounds, whether one or more people are sneezing, coughing, laughing, snoring, breathing heavily, yawning, etc., whether a baby is crying, whether a dog is barking, and the like, or combinations thereof; the ambient factor “ambient light level” may indicate whether it is bright or dim within the user's environment, whether the user is in a natural or artificial environment, whether the user is indoors or outdoors, whether the user's environment is in motion, etc.; the ambient factor “ambient characteristic image” may indicate, based on captured images, whether one or more people are smiling within the user's local environment; and the like, or combinations thereof. For example, a combination of ambient factors may indicate, based on sounds and/or images, whether one or more people are relaxed within the user's local environment, whether one or more people are stressed within the user's local environment, and the like, or combinations thereof. A more detailed description of the various ambient factors will be provided below.

Numerous embodiments of the present invention provide a method and apparatus for matching advertisements with users based (in whole or in part) on a user's current ambient factors. Accordingly, numerous embodiments of the present invention allow a particular advertisement that is relationally associated with a user's current ambient factors to be displayed to the user and not allow advertisements that are not relationally associated with the user's current ambient factors to be displayed. A method for determining whether a particular advertisement should be matched with and, therefore, displayed to a particular user viewing a particular document (e.g., over the internet) based on ambient factors specific to the particular user may, for example, include steps of: identifying target content information for the particular advertisement, wherein the target content information relates to the subject matter for which the advertisement is relevant; identifying target ambient factors for the particular advertisement; analyzing the content of the particular document to identify a set of one or more content topics that are included therein; obtaining a user's ambient factor data (i.e., source ambient factor data such as time data, date data, weather condition data, sound data, and/or image data); analyzing the user's ambient factor data to identify a user's then-current ambient factors (i.e., source ambient factors); comparing the target content information for one or more advertisements to the set of one or more content topics for one or more particular documents being accessed by the user to determine if a content match exists; comparing the target ambient factors for one or more advertisements with one or more of the user's then-current ambient factors to determine if an ambient factor match exists; and displaying a particular advertisement to the user based (in whole or in part) upon whether a content match exists and/or whether an ambient factor match exists and, optionally, upon the degree to which the content and/or ambient factor matches exist.

As used herein, the phrase “target ambient factors” refer to aforementioned ambient factors but are associated with an advertisement. Accordingly, target ambient factors that can be identified include, for example, target time-of-day, target day-of-week, target weather conditions, target ambient sound level, target ambient characteristic sounds, target light level, target ambient characteristic images, etc.

As used herein, the term “document” refers to a variety of different forms of information content. For example, the term “document” can refer to a traditional web document (e.g., an HTML web page), a traditional computer file (e.g., a text file, a word processing file, a .pdf file, etc.) or any other displayable store of text and/or image data. The term “document” can also refer to a table, schedule, catalog, a data file, or any other listing and/or storage of information. The term “document” can also refer to a media file (e.g., an image file, and animation file, a movie file, a music file or other sound file, or a gaming file). The term “document” can also refer to a stream of media content such as streamed video, audio, animation, and/or text.

The many embodiments of the present invention discussed herein may be implemented by a variety of computing platforms containing circuitry adapted to perform the methods disclosed herein (including various advertisement display methods) and having an interface adapted to be engaged by the user. As used herein, the term “circuitry” will be understood by those skilled in the art to refer to dedicated fixed-purpose circuits and/or partially or wholly programmable platforms comprising executable instructions that be implemented as, for example, hardware, firmware, and/or software, all of which are within the scope of the various teachings described. For example, in one embodiment, the computing platform engaged by the user is a traditional personal computer and the advertisement display is a media file accessed over the internet and displayed upon the screen of the computer used by the user. In another embodiment, the computing platform is a processor within a portable digital assistant (PDA) and the advertisement display is a media file accessed over the internet and displayed upon the screen of the personal digital assistant used by the user. In still another embodiment, the computing platform is a processor within a cellular phone or other digital wireless phone and the advertisement display is a media file accessed over the internet or other network and displayed upon a screen of the phone hardware used by the user. In yet another embodiment, the computing platform is a processor within an interactive television system and the advertisement display is a media file accessed over the internet and displayed upon the screen of the interactive television. In a further embodiment, the computing platform is a processor within a portable media player and the advertisement display is a media file accessed over the internet and displayed upon the screen of the portable media player. In yet another embodiment, the computing platform is a processor within an interactive gaming system and the advertisement display is a media file accessed over the internet and displayed upon the screen used by the interactive gaming system. In all embodiments, (e.g., personal computer, portable digital assistant, cellular phone, interactive televisions, portable media player, interactive gaming systems, and/or other enabled devices that display advertisements to users) the display may also include speakers and/or headphones for conveying sounds of the advertisement to the user.

Also, certain sound-based embodiments of the present invention can be implemented in conjunction with a microphone that is local to the user and is connected to the computing hardware, wherein the microphone can be attached to and/or integrated into the enabled devices (e.g., personal computer, portable digital assistant, cellular phone, interactive television system, interactive gaming system). For example, an interactive television system adapted to perform the ambient sound-based embodiments disclosed herein may include a microphone connect to and/or integrated into the television hardware such that it can capture sounds of the user's local environment such as the ambient sounds within the room in which the television is located and, optionally, the ambient sounds within other rooms in the user's home.

As mentioned above, ambient factors are environmental conditions measured or otherwise ascertained about the user's then-current local environment, wherein the environmental conditions might affect, indicate, or otherwise suggest how receptive a particular user might be to a particular advertised product, advertising message, and/or advertisement campaign strategy. The following is a list of exemplary ambient factors that can be used alone, or in combination, consistent with the embodiments disclosed herein:

Time-Of-Day: One type of ambient factor that can be used in conjunction with the methods disclosed herein to improve the matching of advertisements with the then-current state-of-mind of a user is time-of-day. Data indicative of the then-current time-of-day at the local location of the user can be used alone, or in combination with sunrise and sunset timing information specific to the user's local location, to improve the matching of advertisements with the user's then-current state-of-mind. For example, some advertised products, advertised messages, and/or advertising campaign strategies, may be better suited to a user after the sun has gone down in the location that that user is in. At such times, users will likely feel different than when the sun is out and bright because people often have a different state-of-mind after the sun has gone down (e.g., shifting gears from a “work mode” to a “relaxation mode”, or shifting thoughts from outdoor activities to indoor activities, etc.). As a result, some advertised products, advertised messages, and/or advertising campaign strategies may be better suited for users when they are in an “after dark” state-of-mind as compared to when they are in a “daylight” state-of-mind. Other advertised products, advertised messages, and/or advertising campaign strategies, on the other hand, may be better suited to users when the sun is bright and the hour of the day is closer to noon—i.e., a “mid day” state-of-mind. Because people have a tendency to change their mood and/or change the focus of their thoughts based, at least in part upon the time-of-day and/or the location of the sun in the sky, time-of-day used alone or in combination with sunrise and/or sunset data may be an effective ambient factor for the methods disclosed herein. In one embodiment, sunrise and/or sunset data may be data that directly indicates sun position for the user's then-current location or it may be derived based upon the then-current date (day, month, and year) and the then-current location of the user. In one embodiment, some advertised products, advertised messages, and/or advertising campaign strategies may be best suited particular times of day when sun conditions are known without needing to use sunrise and/or sunset data (e.g., very late at night). Other advertised products, advertised messages, and/or advertising campaign strategies may be best suited to very particular sun conditions that are highly dependent upon daily sunrise and/or sunset data. For example, some advertised products, advertised messages, and/or advertising campaign strategies may be best suited to users when the sun is in the process of setting and/or when the sun is in the processes of rising. Using the methods disclosed herein, it can be determined if a user currently has an ambient factor of “sunrise” or an ambient factor of “sunset” and appropriate advertisements can be matched for that user accordingly. For example, if it is determined that a given user is reading a document comparing new cars and it is determined that that user has an ambient factor in his local environment (e.g., based upon time-of-day and sunset data) that his environment outside is currently approaching sunset, the advertisement shown to that user can be an automobile advertisement that depicts the given automobile in a sunset setting—something the user is particularly well suited to receive because he is currently in a sunset state-of-mind. In this way, the visual conditions in an advertisement can be selected to match the general visual conditions of the user's surroundings (e.g., matching advertised sunsets with real sunsets, matching advertised sunrises with real sunrises).

It should be noted that in addition to data indicative of sun position relative to the user's local environment, moon position data can also be used as an ambient factor to match an advertisement with a user's local environmental conditions. For example, it can be determined based upon the current time-of-day and current date for the user, along with moon position data for the user's current location, that the user's local environment is experiencing a full moon. This “full moon” condition can be used as an ambient factor to better match advertisements with the user at that then-current time. For example, the user may be in the process of searching and reviewing documents about mountain climbing—a number of advertisements are identified using the methods disclosed herein that are relevant to mountain vacations, a particular one of the advertisements being selected that depicts Yosemite's Half Dome mountain with a bright full moon above it. In this way, the advertisement can be matched to the user not just based upon his or her interest in mountain climbing, but also based upon local ambient environmental conditions that may be influencing his or her state-of-mind. In one embodiment, the current time-of-day data and/or current date data for a user can be determined using a clock within the user's local computer. In another embodiment, the current time-of-day data and/or current date data for a user can be determined by a remote server computer so long as that server knows the location and/or time-zone from which the user is connecting remotely.

The then-current time-of-day of the user's local environment can be used in a number of different computational methods to influence the level of the match between the user and a particular advertisement. In one embodiment, the then-current time-of-day of the user's local environment is used to compute a value indicative how near the user's then-current time-of-day is from some target time-of-day value that is associated with the given advertisement. For example, a given advertisement might be for Frozen Dinner Meals and the advertiser may have determined that the best time to advertise such frozen dinner meals to people is just before dinner time when a person is likely to be hungry and thinking about dinner. The advertiser may therefore associate a particular target time-of-day with the given advertisement document, for example 5:15 PM. When the matching methods disclosed herein are applied, the then-current time-of day of the user is compared to the target time-of-day for the advertisement, and a value is computed indicating the level of match. For example, if the then-current time-of-day for the user was 5:45 PM, a difference value would be computed indicating the level of match. In one embodiment, this is difference value is a scaling factor divided by one plus the number of minutes between the then-current time-of-day of the user and the target time-of-day of the advertisement. If the scaling factor was set at 120, the value for the example above would be 120 divided by (1+30) wherein 30 is the number of minutes between the then-current time-of day of the user and the target time-of-day of the advertisement. The value computed would therefore be 120/31 which comes out to 3.9. This value is indicative of how near the current time-of-day of the user is to the target time-of-day of the advertisement. For example, if the time had been 7:30 for the user, the same computation would have given a smaller value of 120/(1+135)=0.9. This would indicate less heavily weighted match than the 3.9 value in the first example. It should be noted that many computational methods can be used to determine a match weighting based upon the then-current time of day of the user's local environment and the target time-of-day associated with the advertisement. The scaling methods can be linear, logarithmic, or some other computational scheme that creates a weighting factor based upon the difference between the then-current time-of-day of the user and a target time-of-day associated with a particular advertisement document.

In some embodiments, the target-time-of-day of an advertisement may be a range rather than a specific time. Furthermore, the method of determining the level of match may be based (in whole or in part) upon whether or not the user's then-current time-of-day falls within the range. For example, in categorizing advertisement documents it may be effective and/or convenient in some embodiments of this invention to split the day into daily segments such as early morning, mid-morning, late morning, early afternoon, late afternoon, early evening, late evening, and late night, each of which is associated with a specific range of times. For example, early morning might be defined as the time interval range between 4 am to 7 am. Using such a time-interval method, the matching scheme is based upon whether or not the then-current time-of-day of the user falls within the time-interval associated with the advertisement or not. For example, a particular advertisement might be associated with an early morning daily segment (between 4 am and 7 am) as defined by data associated with and/or included in the advertising document accessed over the web. A heavily weighted match would then be identified by the methods disclosed herein for user's whose then-current time-of-day falls within this early morning time interval and not for user's whose then-current time-of-day falls outside this early morning time interval. For such embodiments, data can be stored for a given advertisement that indicates the specific range or ranges of times that are most effective for that advertisement, and/or data can be stored for a given advertisement that indicates the abstracted daily segment or daily segments such as early afternoon, mid-morning, or late night.

In embodiments that use both time-of-day and data indicative of the position of the sun (i.e., ambient sun conditions), the day may be split into daily segments that reflect common sun positions such as sunrise, dawn, high noon, dusk, sunset, and after dark for such sun positions often affect a user's state-of-mind. Using such a sun-position based daily segmenting scheme, the matching computation is based upon whether or not the user's local environment sun conditions matches the sun-position daily segment or segments associated with a given advertisement as predicted by the user's then-current time-of-day used in conjunction with the then-current sun position database. For example, a particular advertisement might be associated with a sunrise daily segment as defined by data associated with and/or included in the advertising document accessed over the web. A heavily weighted match would then be identified by the methods disclosed herein for a user whose local environment, as predicted from the user's then-current time-of-day used in conjunction with the then-current sun position database, falls within or near a sunrise condition.

Day-of-Week: Another type of ambient factor that can be used in conjunction with the methods disclosed herein to improve the matching of advertisements with the then-current state-of-mind of a user is day-of-week. Data indicative of the then-current day-of-week for the local location of the user can be used alone, or in combination with other information to improve the matching of advertisements with the user's then-current state-of-mind. For example, some advertised products, advertised messages, and/or advertising campaign strategies, may be better suited to a user on weekend days as compared to week days. This is because people often have a different state-of-mind on weekend days (e.g., shifting gears from a “work mode” to a “relaxation mode”, or shifting their thoughts from work related activities to leisure related activities, etc.). As a result, some advertised products, advertised messages, and/or advertising campaign strategies may be better suited for users when they are in a “weekend” state-of-mind as compared to when they are in a “weekday” state-of-mind. Other advertised products, advertised messages, and/or advertising campaign strategies, on the other hand, may be better suited to users when they are in a “weekday” state of state-of-mind. Because people have a tendency to change their mood and/or change the focus of their thoughts based, at least in part upon which day of the week it is, some advertised products, messages, and/or strategies may be better suited to a certain day or days (e.g., Mondays) while other advertised products, messages, and/or strategies may be better suited to other certain day or days (e.g., Fridays).

Abient Weather Conditions: Another type of ambient factor that can be used in conjunction with the methods disclosed herein to improve the matching of advertisements with the then-current state-of-mind of a user is local weather conditions for the user's environment. Data indicative of the then-current weather conditions for the local location of the user can be used alone, or in combination with other information to improve the matching of advertisements with the user's then-current state-of-mind. For example, some advertised products, advertised messages, and/or advertising campaign strategies, may be better suited to a user on rainy days as compared to sunny days. Other advertised products, advertised messages, and/or advertising campaign strategies, may be better suited to a user on hot days as compared to cold days. Some advertised products, advertised messages, and/or advertising campaign strategies, may be better suited to a user on windy days, others on cloudy days, others when a storm is expected or when a storm is in process, and others when it is snowing because people often have a different state-of-mind depending upon the current weather conditions for their local environment. Stated another way, weather affects mood and behaviors. For example, a person may be more receptive to an advertisement for a tropical vacation when it is very cold and cloudy in their local environment. Conversely, a person may not be as receptive to advertisements for outdoor sporting gear when it is cold and raining out. In one embodiment, local weather conditions can be determined by correlating data from an internet weather service with data reflecting the user's then-current location. Local weather conditions can also be determined by weather condition sensors (e.g., temperature, barometric pressure, humidity, light, wind speed, precipitation, and the like, or combinations thereof) connected to a user's local machine. In one embodiment, ambient weather conditions can include one or more basic factors such as cloud cover, the type and intensity of precipitation, the temperature, the humidity, the wind speed, and the barometric pressure. In other embodiments, ambient weather conditions can also include other factors such as the UV Index, Pollen Count, Smog, or other local pollution conditions. In some embodiments implemented in conjunction with coastal users, ambient weather conditions may also include tide conditions (e.g., high-tide and low-tide) and/or include surf conditions (e.g., rough surf, calm surf, and/or the size of local swells). In many embodiments, some ambient factors are used as binary values while other ambient factors are used as analog magnitude and/or intensity (i.e., numerical) values. For example, a numerical level of the UV Index for a local area is an analog value that can be used to determine the degree of relevance of certain advertisements such as advertisement for sunscreen products.

Ambient Ambient Sounds: Another type of ambient factor that can be used in conjunction with the methods disclosed herein to improve the matching of advertisements with the then-current state-of-mind of a user is sound conditions local to the user as detected by one or more microphone components near the user. Ambient sound information can be gathered by the microphone or microphones and converted into digital data through an analog-to-digital converter. The digital data can then analyzed by a computer to identify one or more ambient sound characteristics. Ambient sound characteristics can be general, such as determining the absolute or relative volume of the ambient sound (i.e., the ambient sound level) local to the user. With such data, it can be determined if the user's environment is noisy or quiet. Data indicative of the how noisy or quiet the user's local environment is can be used in the inventive methods alone or in combination with other ambient factors information for the user's then-current local location, to better match advertisements with the user's then-current state-of-mind. For example, some advertised products, advertised messages, and/or advertising campaign strategies, may be better suited to a user who is present in a quiet environment. At such times, user will likely feel different than when he or she is in a loud or noisy environment because people often have a different state-of-mind based upon the noise characteristics of their environment. For example, the user may be in the process of searching and reviewing a document or documents about mountain climbing—a number of advertisements are identified using the methods disclosed herein that are relevant to mountain vacations, a particular one of the advertisements being selected and displayed based in part upon the “quiet” ambient sound characteristics of this user's local environment. For example, the advertisement that was selected might depict a lone climber in the quiet wilderness for it is likely to be a good match for this user's quiet state-of-mind. On the other hand, a different user may be in the process of searching and reviewing the same document or documents about mountain climbing—a number of advertisement are identified using the methods disclosed herein that are relevant to mountain vacations, a particular one of the advertisements being selected based in part upon the “noisy” ambient sound characteristics of this user's local environment. The advertisement that was selected might depict a boisterous group of hikers for it is likely a good match for this user's noisy state-of-mind.

In addition to general assessment of ambient sound such as the volume level described above, ambient sound characteristics can also be specific, determined from the unique form of the digital sound data gathered from the local environment of the user. Using known signal processing techniques and/or sound recognition techniques upon the sound data, particular sounds can be identified based upon their similarity to certain characteristic forms. One example of such sound recognition methods is disclosed in HABITAT TELEMONITORING SYSTEM BASED ON THE SOUND SURVEILLANCE by Castelli, Vacher, Istrate, Besacier, and Sérignat, which is hereby incorporated by reference. Another example of such sound recognition methods is disclosed in a 1999 doctoral dissertation from MIT by Keith Dana Martin entitled Sound-Source Recognition: A Theory and Computational Model, which is also hereby incorporated by reference. Another example of such sound recognition methods is disclosed by Michael Casey in the IEEE TRANSACTIONS ON CIRCUITS AND SYSTEMS FOR VIDEO TECHNOLOGY, VOL. 11, NO. 6, JUNE 2001 in a paper entitled, MPEG-7 Sound-Recognition Tools, which is hereby incorporated by reference. In this paper it is explained that recent advances in pattern recognition methodologies make the automatic identification of characteristic environmental sounds, animal sounds, non-verbal human utterances, possible. For example, human laughter can be identified by performing a spectral analysis on sound data and performing statistical pattern matching with characteristic laughter profiles. Similarly a dog bark can be identified also by performing spectral analysis on sound data and performing statistical pattern matching with characteristic dog bark profiles.

Using these and other sound recognition methods, the following ambient characteristic sounds can be identified in accordance with various embodiments of the present invention: the sound of coughing, the sound of sneezing, the sound of yawning, the sound of laughing, the sound of a baby crying, the sound of automobile traffic, the sound of broken dishes, the sound of a dog or a dog barking, and the like, or combinations thereof. Each of these ambient characteristic sounds, when identified within a user's local environment by automated software routines, can be used alone or in part to match the user with a particular advertisement retrieved and selected over the internet. Each of these ambient characteristic sounds are described in more detail below:

The sound of coughing: In some embodiments of the current invention, software routines are included and configured to process ambient sound data derived from sound signals collected by one or more microphones within the user's local environment. The microphones, for example, can be microphones connected to or integrated with a personal computer the user is then-currently using, a portable digital assistant the user is then-currently using, a computer gaming system the user is then-currently using, an interactive television system the user is then-currently using, a cell phone the user is then-currently using, a portable media player the user is then-currently using, or some other hardware that is capable of displaying advertisements retrieved over the internet. In some of these embodiments, the software routines are configured to identify from the frequency profile, amplitude profile, spectral analysis, and/or some other signal processing analysis technique, the characteristic sound of human coughing. This identification can be a simple binary determination that a coughing has occurred or can be an analog determination indicative of the magnitude, duration, and/or frequency of coughing. For example, the software can derive a cough assessment value that considers the intensity of coughing episodes as well as the number of coughing episodes within a given time period and provides an indication of how “bad a cough” the user (and/or some other person within the user's local environment) then-currently has.

The cough assessment can be a binary yes/no determination indicating if a cough was detected within the sound data and/or if a cough was detected within the sound data having a magnitude, duration, and/or frequency that exceeds certain threshold measures. Alternatively, the cough assessment can produce an analog value indicating “how bad a cough” the user likely has as a function of the magnitude, duration, and/or frequency of coughing identified within the sound data within a given time period. Based upon this cough assessment (alone or in part) the software routines of the current invention identify an advertisement from a pool of available advertisements, to be displayed to the user. For example, an advertisement for cough drops might be displayed to the user based in part upon a large cough assessment value computed for that user's local environment at that time. Alternatively an advertisement for cough medicine, for medical insurance, for medical clinics, or for flu vaccines, might be selected.

Because there may be numerous possible advertisements that are appropriate for a user whose ambient sound data includes human coughing, other factors can be used in combination with the ambient sound analysis to determine which advertisement from the pool of available advertisements is to be displayed to the user. For example, a user might be retrieving for documents on the internet related to vacations—many possible advertisements could be included in the pool of available advertisements related to vacations. Also, ambient sound analysis indicates that significant coughing is occurring within the user's environment. Based upon these two factors (documents retrieved with content related to vacations and ambient sound data collected indicating coughing), an advertisement is selected by the software routines for a warm-climate vacation rather than a cold-climate vacation because a person who currently feels sick is likely to be a state-of-mind that is more receptive to warm climate vacation ideas.

The sound of sneezing: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of human sneezing. This identification can be a simple binary determination that sneezing has occurred or can be an analog determination indicative of the magnitude, duration, and/or frequency of the sneezing. For example the software can derive a sneeze assessment value that considers the intensity of sneezing episodes as well as the number of sneezing episodes within a given time period and provides an indication of how “bad a cold” the user (and/or some other person within the user's local environment) then-currently has.

The sneeze assessment can be a binary determination yes/no indicating if a sneeze was detected within the sound data and/or if a sneeze was detected within the sound data having a magnitude, duration, and/or frequency that exceeds certain threshold measures. Alternatively, the sneeze assessment can produce an analog value indicating “how bad a cold” the user likely has as a function of the magnitude, duration, and/or frequency of sneezing identified within the sound data within a given time period. Based upon this sneeze assessment (alone or in part), the software routines of the current invention identify an advertisement from a pool of available advertisements, to be displayed to the user. For example, an advertisement for Kleenex Tissues might be displayed to the user based in part upon a large sneeze assessment value computed for that user's local environment at that time. Alternatively an advertisement for allergy medication, for decongestant medication, medical insurance, for medical clinics, or for flu vaccines, might be selected. In some embodiments, sneeze assessments are used in combination with cough assessments to derive a value or values indicative of how ill a person might be. In general, because there may be numerous possible advertisements that are appropriate for a user whose ambient sound data includes human sneezing, other factors can be used in combination with the ambient sound analysis to determine which advertisement from the pool of available advertisements is to be displayed to the user.

In many embodiments, ambient characteristic sounds can be used in combination with other ambient factors to achieve more refined matching of advertisements. For example, the ambient sound conditions of sneezing can be used in combination with ambient weather conditions such as temperature and/or pollen count. For example an advertisement of allergy medication could be associated with both a target ambient sound condition of sneezing and an ambient weather condition of a pollen count above a certain threshold value. On the other hand, an advertisement for cold medication could be associated with a target ambient sound condition of sneezing and an ambient weather condition of a pollen count below a certain threshold value. In this way, multiple ambient conditions can be used to improve the chances of relevance of advertisements to a user in a particular environment. In this case, allergy advertisements can be displayed to users sneezing because of pollen allergies and cold medication advertisements can be displayed to a user sneezing because of a cold.

The sound of yawning: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of human yawning. This identification can be a simple binary determination that yawning has occurred or can be an analog determination indicative of the magnitude, duration, and/or frequency of the yawning. For example the software can derive a yawn assessment value that considers the intensity of yawning episodes as well as the number of yawning episodes within a given time period and provides an indication of “how tired” the user (and/or some other person within the user's local environment) then-currently feels.

The yawn assessment can be a binary yes/no determination indicating if a yawn was detected within the sound data and/or if a yawn was detected within the sound data having a magnitude, duration, and/or frequency that exceeds certain threshold measures. Alternatively, the yawn assessment can produce be an analog value indicating “how tired” the user likely has as a function of the magnitude, duration, and/or frequency of yawning identified within the sound data within a given time period. Based upon the yawn assessment, alone or in part, the software routines of the current invention identify an advertisement from a pool of available advertisements, to be displayed to the user. For example, an advertisement for Columbian Coffee might be displayed to the user based in part upon a large yawn assessment value computed for that user's local environment at that time. Alternatively, an advertisement for pillows or mattresses might be selected. Because there may be numerous possible advertisements that are more likely to be appropriate for a user whose ambient sound data includes human yawning, other factors can be used in combination with the ambient sound analysis to determine which advertisement from the pool of available advertisements is to be displayed to the user. For example, two ambient factors can be used in combination such as sound data indicative of yawning and time-of-day data. For example, the software can be configured such that if yawning is detected and time-of-day data indicates that it is the morning or afternoon, then advertisements for stimulants such as coffee and soda are more likely to be selected. If, on the other hand, yawning is detected and time-of-day data indicates that it is evening or night, then advertisements for sleep related products such as mattresses or pillows are selected. This can be achieved by associating two ambient factors with a given advertisement—time-of-day and ambient yawning. A pillow advertisement, for example, can be associated with evening and night time-of-day daily segments and can be associated with the ambient sound of yawning. A coffee advertisement, on the other hand, can be associated with morning and afternoon time-of-day daily segments and can be associated with the ambient sound of yawning. The associating of ambient factors with advertisement documents can be accomplished through data stored within the advertisement document itself and/or through data associated with or otherwise linked to the advertisement document in some other local or distant memory storage location such as a web-based advertising server.

As another example of how the ambient factor of sound indicating yawning can be used to enhance the matching of a user with appropriate advertisements, a user might be retrieving for documents on the internet related to vacations—many possible advertisements could be included in the pool of available advertisements related to vacations. Also, ambient sound analysis indicates that yawning has recently occurred within the user's environment. Based upon these two factors (documents retrieved with content related to vacations and ambient sound data collected indicating yawning), an advertisement is selected by the software routines for a restful vacation rather than a vigorous activity vacation (such as skiing and/or rock climbing) because a person who currently feels tired is likely to be a state-of-mind that is more receptive to restful vacation ideas.

The sound of laughing: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of human laughing. This identification can be a simple binary determination that laughing has occurred or can be an analog determination indicative of the magnitude, duration, and/or frequency of the laughing. For example, the software can derive a laughing assessment value that considers the intensity of laughing episodes as well as the number of laughing episodes within a given time period and provides an indication of the “cheerfulness” in the user's local environment.

The laughing assessment can be a binary yes/no determination indicating if a laugh was detected within the sound data and/or if a laugh was detected within the sound data having a magnitude, duration, and/or frequency that exceeds certain threshold measures. Alternatively, the laughing assessment can produce an analog value indicating “how cheerful” the user likely to be as a function of the magnitude, duration, and/or frequency of laughing identified within the sound data within a given time period. Based upon the laughing assessment (alone or in part), the software routines of the current invention identify an advertisement from a pool of available advertisements, to be displayed to the user. For example, an advertisement for a comedy movie might be displayed to the user based in part upon a large laughing assessment value computed for that user's local environment at that time. Alternatively an advertisement for wine, beer, dance music, or other products associated with a leisure state-of-mind might be selected.

In addition to, or instead of, influencing the product to be advertised to a user based upon the detection of laughing within the ambient sound of a user's local environment, the methods disclosed herein can influence the style and/or informational content of the advertising message selected for a given user. For example, there may be a number of advertisement styles available within a style set for conveying a particular product, some of the styles being of a serious tone and some being of a humorous tone. Based upon the detection of laughing within the ambient sound of the user's local environment, the style of an advertisement conveying a particular product may be humorous tone may be selected over a style conveying the particular product in a serious tone.

Because there may be numerous possible advertisements that are more likely to be appropriate for a user whose ambient sound data includes human laughing, other factors can be used in combination with the ambient sound analysis to determine which advertisement from the pool of available advertisements is to be displayed to the user. As example of how the ambient factor of sound indicating laughing can be used to enhance the matching of a user with appropriate advertisements, a user might be retrieving for documents on the internet related to automobile insurance. Many possible advertisements could be included in the pool of available advertisements related to automobile insurance, even many from the same insurance provider. Also, ambient sound analysis indicates that laughing has recently occurred within the user's local environment. Based upon these two factors (documents retrieved with content related to automobile insurance and ambient sound data collected indicating laughing), an advertisement document is selected by the software routines from the pool of available advertisements and displayed to the user, the one being selecting having a humorous style (or contain fun facts) and being related to automobile insurance (rather than, for example, an auto insurance advertisement that is of a serious style and/or containing serious facts). This is an effective means of automatically selecting advertisements because the user who currently in a local environment with ambient laughing sounds is likely to be in a state-of-mind that is more receptive to humorous advertising messages than serious advertising messages.

The sound of a baby crying: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of a baby crying. This identification can be a simple binary determination that baby crying has occurred or can be an analog determination indicative of the magnitude, duration, and/or frequency of the crying. For example the software can derive a baby crying assessment value that considers the intensity of crying episodes as well as the number of crying episodes within a given time period. The baby crying assessment can be a binary determination yes/no indicating if baby crying was detected within the sound data and/or if baby crying was detected within the sound data having a magnitude, duration, and/or frequency that exceeds certain threshold measures. Alternatively, the crying assessment can produce an analog value indicating the severity of the crying as a function of the magnitude, duration, and/or frequency of baby crying identified within the sound data within a given time period. Based upon this crying assessment, alone or in part, the software routines of the current invention identify an advertisement from a pool of available advertisements, to be displayed to the user. For example, an advertisement for diapers might be displayed to the user based in part upon the crying assessment value computed for that user's local environment at that time. Alternatively, an advertisement for baby medication, baby wipes, baby thermometers, baby monitors, or for other baby related products might be selected. Because there may be numerous possible advertisements that are appropriate for a user who has a baby in their local environment as determined by an analysis of ambient sound data that indicates characteristic human baby crying sounds, other factors can be used in combination with the ambient sound analysis to determine which advertisement from the pool of available advertisements is to be displayed to the user (e.g., time-of-day). For example, the software can be configured such that if baby crying is detected and time-of-day data indicates that it is the morning or afternoon, then advertisements for daytime baby products such as baby shoes and baby toys are more likely to be selected. If, on the other hand, baby crying is detected and time-of-day data indicates that it is evening or night, then advertisements for night-time related baby products such as baby monitors, baby pajamas, or baby cribs are selected and displayed to the user. This can be achieved by associating two ambient factors with advertisement documents (e.g., time-of-day and baby crying). A baby stroller advertisement, for example, can be associated with morning and afternoon time-of-day daily segments and can be associated with the ambient sound of baby crying. A baby crib advertisement, on the other hand, can be associated with evening and night time-of-day daily segments and can be associated with the ambient sound of baby crying. The associating of ambient factors with advertisement documents can be accomplished through data stored within the advertisement document itself and/or through data associated with or otherwise linked to the advertisement document in some other local or distant memory storage location such as a web-based advertising server.

The sound of dog barking: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of one or more dogs barking. This identification can be a simple binary determination that dog barking has occurred in the user's local environment or can be an analog determination indicative of the magnitude, duration, and/or frequency of the barking that has occurred in the user's local environment. For example, the software can derive a dog barking assessment value that considers the intensity of barking episodes as well as the number of barking episodes within a given time period. The dog barking assessment can be a binary determination yes/no indicating if dog barking was detected within the sound data and/or if dog barking was detected within the sound data having a magnitude, duration, and/or frequency that exceeds certain threshold measures. Alternatively, the barking assessment can produce an analog value indicating the intensity of the barking as a function of the magnitude, duration, and/or frequency of barking sounds identified within the sound data within a given time period. Based upon this barking assessment (alone or in part), the software routines of the current invention identify an advertisement from a pool of available advertisements, to be displayed to the user. For example, an advertisement for dog food might be displayed to the user based in part upon the barking assessment value computed for that user's local environment at that time. Alternatively, an advertisement for flea and tick medication, spay and neuter public service announcements, dog friendly hotels, carpet cleaning services, or for other dog related products and/or products that might appeal to dog owners. Because there may be numerous possible advertisements that are appropriate for a user who has a dog in their local environment as determined by an analysis of ambient sound data that indicates characteristic dog sounds, other factors can be used in combination with the ambient sound analysis to determine which advertisement from the pool of available advertisements is to be displayed to the user. For example, the software can be configured such that if dog barking is detected at a time when time-of-day data indicates that it is late at night, then advertisements for earplugs, dog training, and/or other advertisements related to dog barking as a nuisance are selected and displayed to the user. If, on the other hand, dog barking is detected and time-of-day data indicates that it is mid afternoon, then advertisements for dog toys, dog food, dog beds, and/or other dog related products are selected and displayed to the user. This can be achieved by associating two ambient factors with advertisement documents—time-of-day and dog barking. A dog food advertisement, for example, can be associated with morning and afternoon time-of-day daily segments and can be associated with the ambient sound of dog barking. An advertisement for earplugs, on the other hand, can be associated with late night time-of-day daily segments and with the ambient sound of dog barking. The associating of ambient factors with advertisement documents can be accomplished through data stored within the advertisement document itself and/or through data associated with or otherwise linked to the advertisement document in some other local or distant memory storage location such as a web-based advertising server.

The sound of snoring: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of one or more people snoring. This identification can be a simple binary determination that snoring has occurred in the user's local environment or can be an analog determination indicative of the magnitude, duration, and/or frequency of the snoring that has occurred in the user's local environment. For example the software can derive a snoring assessment value that considers the intensity of snoring episodes as well as the number of snoring episodes within a given time period. The snoring assessment can be a binary determination yes/no indicating if snoring was detected within the sound data and/or if snoring was detected within the sound data having a magnitude, duration, and/or frequency that exceeds certain threshold measures. Alternatively, the snoring assessment can produce an analog value indicating the intensity of the snoring as a function of the magnitude, duration, and/or frequency of snoring sounds identified within the sound data within a given time period. Based upon this snoring assessment (alone or in part), the software routines of the current invention identify an advertisement from a pool of available advertisements, to be displayed to the user. For example, an advertisement for snoring remedy medications or equipment might be displayed to the user based in part upon the snoring assessment value computed for that user's local environment at that time.

The sound of heavy breathing: In some embodiments of the current invention, software routines are included and configured to process ambient sound data derived from sound signals collected by one or more microphones within the user's local environment. The software routines are configured to identify from the frequency profile, amplitude profile, spectral analysis, and/or some other signal processing analysis technique, the characteristic sound of one or more heavy breathing. This identification can be a simple binary determination that heavy breathing has occurred in the user's local environment or can be an analog determination indicative of the magnitude, duration, and/or frequency of the breathing that has occurred in the user's local environment. For example, the software can derive a breathing assessment that considers the intensity of breathing within a given time period. Based upon this breathing assessment, alone or in part, the software routines of the current invention identify an advertisement from a pool of available advertisements, to be displayed to the user. For example, heavy breathing may be an indication that a user is engaged in strenuous exercise and so an advertisement for exercise equipment might be displayed to the user based in part upon the breathing assessment value computed for that user's local environment at that time. As a more detailed example the computing platform might be a portable media player through which a user is listening to music downloaded over the internet. A microphone connected to the portable media player records sounds local to the user and software running on the portable media player performs an analysis upon the resulting sound data, determining the sound of heavy breathing. Such heavy breathing is likely to imply that the user is out running, walking, or otherwise engaged in exercise while using the portable media player. The methods of the invention disclosed herein result in an advertisement being displayed to the user for athletic wear clothing. This is achieved as a result of one or more advertisements related to athletic wear clothing being associated with the ambient sound factor of heavy breathing. The associating of the ambient sound factor with advertisement documents is accomplished in some embodiments through data stored within the advertisement document itself and/or through data associated with or otherwise linked to the advertisement document in some other local or distant memory storage location such as a web-based advertising server.

Sound Capture Enhancement using Media Noise Canceling: Numerous embodiments of the current invention capture, process, and analyze ambient sounds from a user's local environment. This can be done by using one or more microphones local to the user, wherein the microphone or microphones are connected to the computing hardware that displays advertisements as required of the various inventive methods disclosed herein. For example, the microphone or microphones are attached to and/or integrated into the devices such as personal computers, portable digital assistants, cellular phones, or interactive television systems. As a specific example, an interactive television system equipped with the ambient sound related inventive methods disclosed herein would have a microphone connected to it and/or integrated into the television hardware such that it can capture sounds of the user's local environment such as the ambient sounds within the room in which the television is set up and optionally the ambient sounds within other rooms in the user's home. This creates a potential problem in that the microphone connected to the interactive television will pick up all ambient sounds in the local environment, including sounds from the speakers of the television itself. These sounds from the TV may include sounds such as laughter, baby crying, dog barking, coughing, sneezing, yawning, and/or other ambient sounds that are being specifically processed for by the methods disclosed herein. Because such sounds originate from the interactive TV itself and not from the user's local environment, noise canceling technology (also referred to as sound suppression technology) can be used in hardware and/or software to negate the sounds that originate from the interactive TV, attenuating them and/or eliminating them from the sound signal captured by the microphone. This works by taking sound signals going to the interactive TV speakers, inverting the sound signals (or putting them out of phase), and adding the signal to that which is captured by the microphone, thereby canceling those portions of the microphone signal that are the same as those produced by the TV speakers. Once the sounds have been canceled out and/or attenuated, the sound signal can be processed for ambient sound analysis. In this way, the sound of a baby crying (or other ambient sound) that originates from within the user's environment but not from the TV itself can be identified by software routines running on the TV such that appropriate advertisements could be displayed in response to the identification of such baby crying sounds (or other ambient sounds).

Ambient Images: Another type of ambient factor that can be used in conjunction with the methods disclosed herein to improve the matching of advertisements with the then-current state-of-mind of a user are images local to the user as detected by one or more cameras near the user. Ambient characteristic image information is gathered by the camera or cameras as digital image data. The digital image data is then analyzed by a computer running image processing routines to identify one or more ambient image characteristics. Ambient image characteristics can be general, such as determining the absolute or relative brightness of the ambient image (i.e., ambient light level) local to the user. With such data it can be determined if the user is in a bright environment or a dark environment. Data indicative of the how bright or dark the user's local environment is can be used alone or in combination with other ambient factors for the user's then-current local location, to improve the matching of advertisements with the then-current state-of-mind of a user. For example, some advertised products, advertised messages, and/or advertising campaign strategies, may be better suited to a user who is present in a bright environment. At such a time, users will likely feel different than when he or she is in a dark or dim environment. This is because people often have a different state-of-mind based upon the brightness characteristics of their environment. In addition to or instead of determining the brightness of the user's local environment from ambient image data, other ambient factors can be determined by analyzing image data such as whether the user is inside or outdoors, whether the user is in a stationary local environment or a local environment that is in motion, whether the user is in a natural environment or an urban environment, and/or whether the user is alone within his or her local environment or whether the user is accompanied by one or more other people.

Reference will now be made to the accompanying drawings. Any discussion with respect to the references is not to be taken in a limiting sense but is provided merely for the purpose of describing general principles of exemplary embodiments.

In accordance with many embodiments of the present invention, to methods and apparatus are disclosed herein for selecting advertisements from a pool of available advertisements for display to a particular user. The selecting is based upon: 1) whether the advertisements are relevant to one or more documents recently accessed by the particular user; and 2) whether the advertisements are associated with ambient factors that are identified to be present within the user's local environment.

In one embodiment, the document is a web page and the advertisements are electronic files that are capable of being rendered on that web page. A set (e.g., a list) of topics corresponding to the web page is generated by analyzing the content of the web page. In one embodiment, the content of the web page may be analyzed by computing a term vector for the web page and selecting the top N terms from that vector. The list of topics is compared to target information associated with the advertisements (e.g., keywords specified for the advertisements) to determine which of the advertisements are relevant to the web page based upon content. In addition, one or more ambient factors corresponding to the user's local environment are identified. In one implementation, sound data is captured from the user's local environment through a microphone and processed in software using sound recognition methods. If a particular characteristic sound is identified (e.g., the sound of a baby crying) that ambient factor is identified. The identified ambient factors are then compared to target ambient factors associated with the advertisements. Based upon: 1) the matching of term vectors for the web page with the target information associated with the advertisement; and 2) upon the matching of identified ambient factors with the target ambient factors associated with the advertisement, one or more relevant advertisements may then be associated with the web page and rendered (e.g., displayed) with the web page. Those skilled in the art will recognize that many other implementations are possible, consistent with the present invention.

A. Environment and Architecture

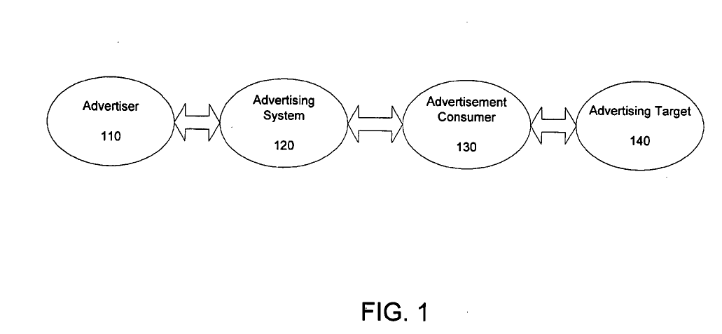

FIG. 1 is a diagram illustrating an environment within which the invention may be implemented.

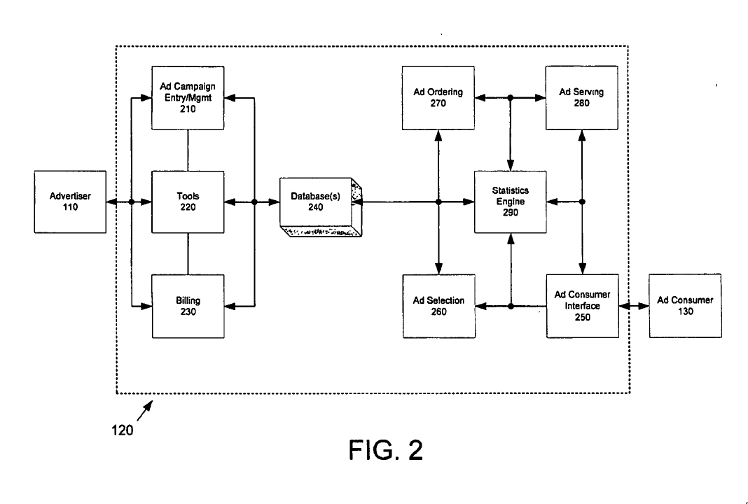

As shown in FIG. 1, the environment includes an advertiser 110, an advertising system 120, an advertisement consumer 130, and an advertising target 140. Advertiser 110 may be the party that directly sells the goods or services being advertised (e.g., Amazon.com) or an agent authorized to act on the advertiser's behalf. The advertisement desired by advertiser 110 may exist in a variety of forms ranging from standard print advertisements, online advertisements, audio advertisements, audio/visual advertisements, or any other type of sensory message desired. Advertising system 120 interfaces with both the advertiser 110 and the advertisement consumer 130 and may perform a variety of functions, as explained in more detail below in reference to FIG. 2. Embodiments of the present invention may be implemented in conjunction with advertising system 120. Advertisement consumer 130 is the entity that will issue a request for advertisements to advertising system 120, obtain the advertisements from advertising system 120, and present the advertisement to the advertising target 140. Typically, the advertisement consumer 130 is the entity that provides the content with which the advertisement is to be associated. In one embodiment, the advertisement consumer 130 is a search engine, such as that employed by Google, Inc. at www.google.com. Advertising target 140 is the individual (or set of individuals) who ultimately receive the advertisement. In the case of visual advertisements, for example, the advertisement target 140 is the person who views the advertisement.

FIG. 2 is a diagram functionally illustrating an advertising system consistent with the invention.

As shown in FIG. 2, the advertising system 120 includes an ad campaign entry and management component 210, a tools component 220, a billing component 230, one or more databases 240, an ad consumer interface component 250, an ad selection component 260, an ad ordering component 270, an ad serving component 280, and a statistics engine component 290. When embodiments of the present invention are implemented in conjunction with advertising system 120, they may primarily interface with the ad selection component 260. To help understand the invention, other components of the advertising system will be explained below. Furthermore, although FIG. 2 shows a particular arrangement of components constituting advertisement system 120, those skilled in the art will recognize that not all components need be arranged as shown, not all components are required, and that other components may be added to, or replace, those shown.

Ad entry and management component 210 is the component by which the advertiser enters information required for an advertising campaign and manages the campaign. An ad campaign contains one or more advertisements that are related in some manner. For example, the Ford Motor Company may have an ad campaign for zero percent financing, which could contain a series of advertisements related to that topic. Among the other things that could be provided by an advertiser through ad entry and management component 210 are the following: one or more advertising creatives (simply referred to as “ads” or “advertisements”), one or more sets of keywords or topics associated with each of those creatives (which may be used as targeting information for the ads), one or more ambient factors associated with each of those creatives (either as binary ambient factor associations or as analog ambient factor values and/or ranges of ambient factor values to be associated with those creatives); geographic targeting information, a value indication for the advertisement, start date, end date, etc. The data required for, or obtained by, ad entry and management component 210 resides in one of the databases 240. In one embodiment, target ambient factor values can include target time-of-day, target day-of-week, target weather conditions, target ambient sounds, target ambient images, and the like, or combinations thereof. In another embodiment, ambient factor weighting values may also be stored, wherein each ambient factor weighting value indicates how much importance a certain target ambient factor should be given as compared to other target ambient factors that are used to match a particular advertisement with a particular user accessing one or more particular documents. For example, the ambient factor weighting values might indicate that the target time-of-day has less of an effect upon advertisement matching than does the target day-of-week which, in turn, has even less of an effect upon advertisement matching than does a target ambient sound. Accordingly, the degree to which each of the target ambient factors is weighted as compared to the other target ambient factors within the advertisement selection process is represented by the set of ambient factor weighting values. Also, the degree to which each of the target ambient factors is weighted as compared to other matching criteria such as keyword or topic matching can also, optionally, be represented by the set of ambient factor weighting values along with other content specific weighting factors.

Tools component 220 contains a variety of tools designed to help the advertiser 110 create, monitor, and manage its campaigns. For example, tools component 220 may contain a tool for helping advertiser 110 to estimate the number of impressions an ad will receive for a particular keyword or topic. Similarly, tools component 220 may be used to help advertiser 110 to generate a list of keywords or topics for a given advertisement, or to generate additional keywords or topics based on representative ones supplied by advertiser 110. Similarly, tools component 220 may be used to help advertiser 110 to generate one or more ambient factors to be associated with a given advertisement, or to generate additional ambient factors based on representative ambient factors supplied by advertiser 110. Other possible tools may be provided as well. Depending on the nature of the tool one or more databases 240 may be used to gather or store information.

Billing component 230 helps perform billing-related functions. For example, billing component 230 generates invoices for a particular advertiser 110 or ad campaign. In addition, billing component 230 may be used by advertiser 110 to monitor the amount being expended for its various campaigns. The data required for, or obtained by, billing component 230 resides in a database 240.

Databases 240 contain a variety of data used by advertising system 120. In addition to the information mentioned above in reference to ad entry and management system 210, databases 240 may contain statistical information about what ads have been shown, how often they have been shown, the number of times they have been selected, who has selected those ads, how often display of the ad has led to consummation of a transaction, etc. Although the databases 240 are shown in FIG. 2 as one unit, one of ordinary skill in the art will recognize that multiple databases may be employed for gathering and storing information used in advertising system 120.

Ad consumer interface 250 is a component that interfaces with ad consumer 130 to obtain or send information. For example, ad consumer 130 may send a request for one or more advertisements to ad consumer interface 250. The request may include information such as the site requesting the advertisement, any information available to aid in selecting the advertisement, the number of ads requested, etc. In response, ad consumer interface 250 may provide one or more advertisements to ad consumer 130. In addition, ad consumer 130 may send information about the performance of the advertisement back to the ad system via the ad consumer interface 250. This may include, for example, the statistical information described above in reference to a database 240. The data required for, or obtained by, ad consumer interface component 250 resides in a database 240.

Ad selection component 260 receives a request for a specified number of advertisements, coupled with information to help select the appropriate advertisements. This information may include, for example, a search query specified by an end user. Alternatively, or in addition, as described in more detail below, this information may include data related to the content of the page for which the advertisements are being requested. Alternatively, or additionally, this information may include data related to ambient factors identified for the local environment of the particular user or users for whom the advertisements are being requested, as will be described in more detail below.

Ad ordering component 270 receives a list of relevant ads from ad selection component 260 and determines a preference order in which they should be rendered to an end user. For example, relevant ads may be ordered based on the value indication associated with each ad. These ordered ads may be provided to an ad serving component 280.

Ad serving component 280 receives an ordered list of ads from ad ordering component 270, and formats that list into a manner suitable for presenting to ad consumer 130. This may involve, for example, rendering the ads into hypertext markup language (HTML), into a proprietary data format, etc.

Statistics engine 290 contains information pertaining to the selection and performance of advertisements. For example, statistics engine 290 may log the information provided by ad consumer 130 as part of an ad request, the ads selected for that request by ad selection component 260, the order selected by ad ordering component 270, and the presentation of the ads by ad serving component 280. In addition, statistics engine 290 may log information about what happens with the advertisement once it has been provided to ad consumer 130. This includes information such as on what location the ad was provided, what the response was to the advertisement, what the effect was of the advertisement, etc. The statistics engine 290 may also log information about which ambient factors were present in the local environment of users who accessed the advertisement, the ambient factors being optionally correlated with what response such users had to the advertisement and/or what effect the advertisement had. In this way, the statistics engine 290 can generate a statistical measure of how the presence of ambient factors in users local environments are statistically correlated to the effectiveness of a particular advertisement upon such users.

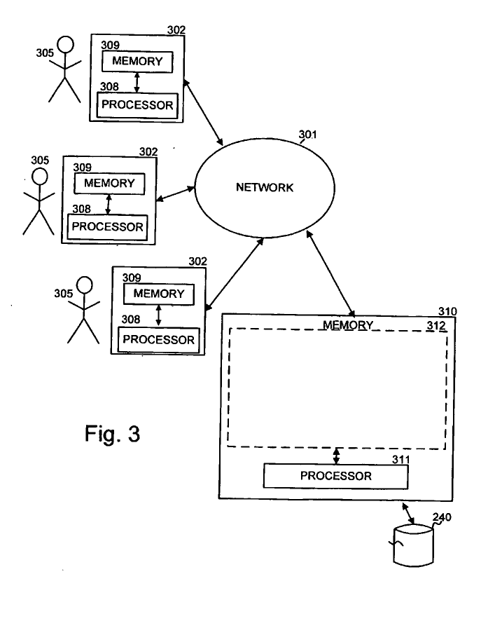

FIG. 3 is a diagram illustrating an architecture in which the present invention may be implemented.

As shown in FIG. 3, the architecture includes multiple client devices 302, a server device 310, and a network 301, which may be, for example, the Internet. Client devices 302 each include a computer-readable medium 309, such as random access memory, coupled to a processor 308. Processor 308 executes program instructions stored in memory 309. Client devices 302 may also include a number of additional external or internal devices, such as, without limitation, a mouse, a CD-ROM, a keyboard, a microphone, a camera, and a display. Thus, as will be appreciated by those skilled in the art, the client devices may be personal computers, personal digital assistances, mobile phones, content players, interactive television systems, interactive gaming devices, etc.

Through client devices 302, requesters 305 can communicate over network 301 with each other and with other systems and devices coupled to network 301, such as server device 310. Requestors 305 may, for example, be advertisers 110, advertisement consumer 130, or advertising target 140. Similar to client devices 302, server device 310 may include a processor 311 coupled to a computer readable memory 312. Server device 310 may additionally include a secondary storage element, such as a database 240.

Client processors 308 and server processor 311 can be any of a number of well known micro-processors, such as processors from Intel Corporation, of Santa Clara, Calif. In general, client device 302 may be any type of computing platform connected to a network and that interacts with application programs, such as a digital assistant or a “smart” cellular telephone or pager or a portable media player or a computer gaming system. It could also be an interactive television system that connects to a central server and receives individualized programming and/or individualized advertising over the internet or other bidirectional communication connection. Server 310, although depicted as a single computer system, may be implemented as a network of computer processors. Memory 312 may contain a number of programs, such as the components described above in reference to FIG. 2.

B. Operation

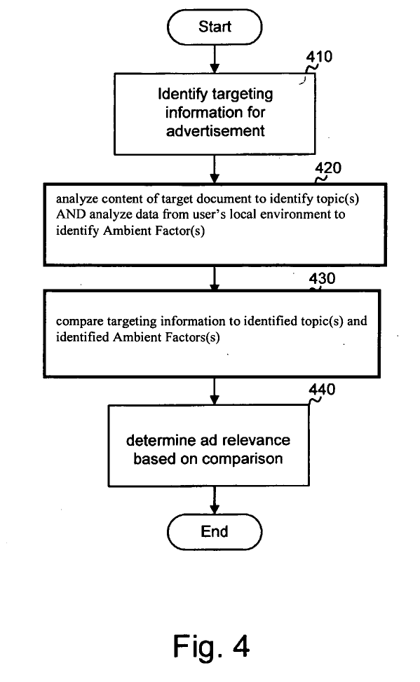

FIG. 4 is a flow diagram of an exemplary method for determining if an advertisement is relevant to a document, consistent with an exemplary embodiment the present invention.

As described above, the term “document” can includes any type of paper or electronic document or file, including audio, video, image, text, etc. That is, as will be appreciated by one skilled in the art, a “document” as used in the specification is any machine-readable and machine-storable work product. A document may be a file, a combination of files, one or more files with embedded links to other files, etc. For the sake of illustration, it may be understood that the process described herein takes place within the ad selection component 260, although those skilled in the art will recognize that it need not take place in that component alone.

The order of steps within the method shown in FIG. 4 is not limited as shown. At step 410, targeting information for an advertisement is identified. In one embodiment, the targeting information may be in the form of a list of keywords or phrases associated with the advertisement (e.g., “Honda”, “Honda cars”, “cars”, etc.) as well as one or more ambient factors (e.g., weather condition of sunny), as provided by advertiser 110 through ad campaign entry and management component 210. Alternatively, or in addition, the targeting information may be determined algorithmically, based on the content of the advertisement, the goods or services being advertised, the targeting of other related advertisements, etc. For example, if the content of the advertisement includes “Honda offers the best selling convertible cars on the market!”, the terms “Honda” or “cars” may be extracted from that content. In addition, an algorithm could be established that automatically associates advertisements that mention the words “convertible” to ambient factors of “sunny” (because people are likely to be more receptive to advertisements about convertible cars when it is a sunny day in their local environment). In this way, the ad for the convertible Honda can be automatically prioritized for users whose local environments are then-currently showing an ambient weather factor of “sunny”. The targeting information may also include other demographic information (e.g., geographic location, affluence) that are neither related to the content of the document nor to the ambient factor(s).

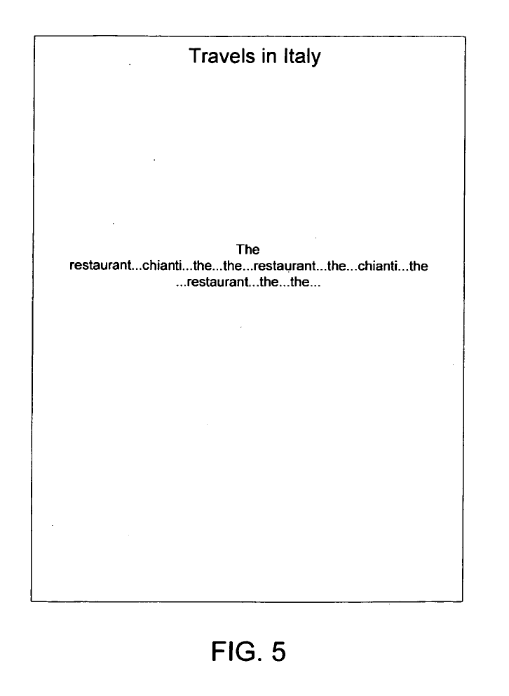

Next, at step 420, the target document (i.e., the document corresponding to which a relevant advertisement is requested) is analyzed to identify a topic and/or topics corresponding to that target document. The target document may be stored on a database 240 or may be provided by ad consumer 130 via ad consumer interface component 250. There are numerous ways in which the target document may be analyzed to identify this topic, as described below in reference to FIG. 5 and related text. Also, one or more ambient factors are identified for the user's local environment as described previously in this disclosure. The ambient factors may include, but are not limited to, the time-of-day in the user's local environment, the day-of-the-week in the user's local environment, one or more weather conditions in the user's local vicinity, one or more identified sounds from within the user's local environment, and/or one or more identified visual images from within the user's local environment. The topic and/or topics and the ambient factors comprise the targeting information.

Next, at step 430, the targeting information identified in stage 410 is compared to the one or more topics identified in stage 420 to determine if a match exists. The targeting information identified in stage 410 is also compared to the one or more ambient factors identified in stage 420 to determine if a match exists. A “match” need not be an exact match. Instead, a match is an indication of a relatively high degree of similarly, and/or a predetermined (e.g., absolute) degree of similarity. If one or more matches exist, the advertisement is determined to be relevant to the target document (step 440) and may be provided to ad ordering component 270, for eventual provision to ad consumer 130 via ad consumer interface component 250. If more than one match exists, the ambient factor weighting values and/or content specific weighting factors are used to determine the level of impact that each of the matches has upon the advertisement selection.

Those skilled in the art will also recognize that the functions described in each step are illustrative only, and are not intended to be limiting.

As disclosed in pending US Patent Application Publication No. 2004/0059708, one way to identify a topic corresponding to the target document is by analyzing some or all text within the target document, which shall be illustrated in reference to FIG. 5. FIG. 5 shows a sample document, entitled “Travels in Italy”, which contains a collection of travel-related information pertaining to Italy. The document text contains the term “restaurant” (appearing 20 times), “chianti” (appearing 10 times), and “the” (appearing 100 times). It could be determined that one or more of each term (word or phrase) that appears in the title of the target document corresponds to a topic of the target document. On this basis, the topics for this document may be “travels”, “in”, and/or “italy.” Alternatively, it could be determined that one or more of each term that appears in the body of the target document corresponds to a topic of the target document. In the simplest case, each term within the target document would be identified as a topic. A slightly more complex approach would be to identify a term as a topic if it appears in the target document more than N times, such as N=2 (and indeed such a threshold-based approach could be used whenever terms within text are being analyzed). Even more complex analysis could be performed, such as by using a term vector for the target document, which assigns weights to each term. For example, terms that appear frequently in the target document may be assigned a relatively higher weight than those that appear less frequently. And so the term “the” would have a higher weight than “restaurant”, which would have a higher weight than “chianti”.

In addition, the weighting could be adjusted to give higher weight to terms that appear less frequently in a collection, such as a collection to which the document belongs or the general collection of documents. For example, the term “chianti” does not appear very commonly across the general collection of documents and so its weight may be boosted. Conversely, the term “the” appears so frequently across a collection of documents that its weight may be reduced or eliminated altogether.

In any situation, where terms within text are assigned weights or scores, those resulting scores may be used to determine which terms will be identified as topics for the target document. For example, it may be determined that only the top scoring term would constitute a topic for the target document. Alternatively, or in addition, it may be determined that the top Z terms (or a subset thereof) will constitute topics for the target document, with Z being some defined number. Alternatively, or in addition, it may be determined that terms having a score that exceeds Y (or a subset thereof) will constitute topics for the target document, with Y being some defined number. Thus, as one skilled in the art will appreciate, topics may be determined based on absolute and/or relative criteria.

Alternatively, or in addition to using text or other information within the target document, meta-information associated with the target document may be used. For example, a reference to the target document by another document may contain a brief description of the target document. Assume a document called “Entertainment” that contains a reference to the target document and describes it as “For a description of restaurants and wine in Italy, see ‘Travels in Italy’.” In the context of a web page, this is often described as anchor text. One or more such brief descriptions may be used to revise (figuratively) the target document by supplementing or replacing some or all of its content with the brief descriptions. So, for example, the topic could be identified from the combination of the target document's title and the brief descriptions of the target document.

Alternatively, or in addition to the brief descriptions from these references, the references themselves may be used. For example, a reference from another document to the target document may be used as an indication that the two documents are similar. Alternatively, or in addition, a reference from the target document to another document may be used as an indication that the two documents are similar. So a reference between the “Entertainment” document and the “Travels in Italy” document may indicate that the two are related. In the context of web pages, these references occur in the form of links from one web page to another. On this basis, the content (or meta-information) of the other document may be used to revise (figuratively) the target document by supplementing or replacing its content with that of the other document. The revised target document's content may then be analyzed using the techniques described above to identify one or more topics.

Alternatively, or addition to using the content (including perhaps metadata) associated with a target document, other techniques may be used to identify one or more topics for the target document. For example, the search query history of one or more users who visit the target document (or target web page) may be used to identify a topic for the target document or web page, on the theory that a visit to the target document that is temporally proximate to that search query history indicates that the user thought the concepts were related. For example, if a user searched for “italian wine” and then soon afterwards visited the “Travels in Italy” document, the content of that prior search could be used to determine that “italian” and/or “wine” are potential topics for the “Travels in Italy” document. Using one or more of the various techniques described above, or other techniques, one or more topics may be identified for the target document. Once these topics have been identified, a variety of techniques may be used to determine other topics that are related to those identified topics. For example, a thesaurus could be used to determine other topics (e.g., synonyms) that are closely related to the identified topics or that are conceptually similar to the identified topics.

In other embodiments, methods and systems for matching particular advertisements with a particular user based (in whole or in part) upon certain ambient factors may not use content topics associated with documents being accessed and/or reviewed by the particular user. For example, particular advertisements may be matched with particular users based wholly upon whether a particular ambient factor (e.g., an ambient sound) is detected within the user's local environment. For example, the ambient sound of coughing may be detected within the local environment of the user. Based wholly upon this ambient sound, an advertisement may be selected and displayed to the user, wherein the advertisement has the ambient sound associated with it using the methods and apparatus disclosed previously. In this example, the advertisement that has the ambient sound of coughing associated with it may be, for example, an advertisement for cough syrup, cough drops, allergy medication, or asthma medication.

In another example, a method for matching particular advertisements with a particular user may be based partly upon whether a particular ambient sound is detected within the user's local environment and based partly upon other factors that are not ambient factors for the user (i.e., source ambient factors). Such other factors may include a demographic statistic associated with the user (i.e., source demographic information) which indicates, for example, that he or she is wealthy. The ambient sound of coughing may be detected within the local environment of that user. Based upon this ambient sound, a number of relevant advertisements may be identified, all of which are associated with the ambient sound of coughing. One of the number of relevant advertisements is specifically selected based in part upon the wealthy demographic information for that user. For example, a particular advertisement is selected from the number of relevant advertisements (and/or a particular advertisement style is selected from a style set of a particular advertisement and/or a particular informational content is selected from a set of informational content topics) that reflects the demographic information of the user (e.g., that depicts a wealthy couple discussing the merits of a particular brand of cold medicine). In this way, one or more particular advertisements can be matched to a particular user based in part upon a matching of target ambient factors associated with an advertisement and the then-current ambient factor detected for the user's local environment and based in part upon determinations other than a matching of ambient factors (e.g., target demographic information specific to an advertisement).

In accordance with other embodiments, methods and systems may be provided for matching particular advertisements with a particular user based (in whole or in part) upon certain bodily ambient factors that relate to the user's body itself. Sensors can be employed to measure certain conditions of the user's body. For example, digital thermometers can be employed to measure a user's body temperature, digital blood pressure sensors can be employed to measure a user's blood pressure and/or digital pulse meters can be employed to measure a user's heart rate. Data from the sensors can be communicated to a computing platform used by the user by a wireless interface (e.g., via a Bluetooth connection) or by a wired interface (e.g., via a USB cable). The absolute magnitude of such sensor values and/or relative changes in such sensor values can be used as bodily ambient factors (which are a unique class of ambient factors that relate to the user's body itself). Based in whole or in part upon then-current bodily ambient factors recorded for a particular user, a particular advertisement can be deselected and displayed to the user using the matching methods and apparatus disclosed throughout this document. For example, if a user's bodily ambient factors include blood pressure data that shows a recent increase in blood pressure sensor readings and/or an absolute value of blood pressure sensor readings that is above some threshold value or within some particular range, an advertisement for blood pressure medication might be selected and displayed to the user and/or an advertisement for blood pressure friendly food might be selected and displayed to the user. If, for example, if a user's bodily ambient factors include body weight data that shows a recent increase in body weight sensor readings and/or an absolute value of body weight sensor readings that is above some threshold value or within some particular range, an advertisement for low calorie food might be selected and displayed to the user and/or an advertisement for a weight loss program might be selected and displayed to the user and/or an advertisement for some other product might be selected that depicts heavier individuals in the advertising campaign. If, for example, if a user's bodily ambient factors include body weight data that shows a recent decrease in body weight sensor readings and/or an absolute value of body weight sensor readings that is below some threshold value or within some particular range, an advertisement for thin fitting clothing might be selected and displayed to the user and/or an advertisement for some other product might be selected and displayed to a user that depicts thinner individuals in the campaign for the product. If, for example, if a user's bodily ambient factors include body temperature sensor that shows or an absolute value of body temperature sensor readings that is above some threshold value or within some particular range, an advertisement for fever reducing medication might be selected and displayed to the user and/or an advertisement for some other product might be selected and displayed to a user that depicts sick people.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of matching an advertisement to a user engaging a computer interface, the method comprising:
identifying a plurality of advertisements having a predetermined relevance to the user based at least in part upon at least one of a search query entered by the user and the contents of a target document viewed by the user;
obtaining at least one source ambient factor for the user, wherein the source ambient factor describes at least one of a current variable environmental condition and a current variable bodily condition of the user;
selecting one of the plurality of identified advertisements based at least in part upon at least one source ambient factor obtained for the user and at least one predetermined relational association between a target ambient factor and the selected one of the plurality of identified advertisements; and
displaying the selected advertisement to the user and not displaying the other of the plurality of advertisements.

2. The method of claim 1, further comprising accessing the at least one predetermined relational association from a data store including a plurality of relational associations between particular advertisements and particular target ambient factors.

3. The method of claim 1, wherein the source ambient factor is a current weather condition in the environment of the user and wherein a plurality of the identified advertisements are each relationally associated with at least one of a plurality of different weather condition target factors.

4. The method of claim 3, wherein the current weather condition is a current sun condition in the environment of the user and wherein a plurality of the identified advertisements are each relationally associated with at least one of a plurality of different sun condition target factors.

5. The method of claim 3, wherein the current weather condition is a current temperature condition in the environment of the user and wherein a plurality of the identified advertisements are each relationally associated with at least one of a plurality of different temperature condition target factors.

6. The method of claim 1, wherein each of the plurality of identified advertisements are about the same product and present the product using a different style.

7. The method of claim 6, wherein each messaging style presents the product in a manner that targets a different state of mind of the user.

8. The method of claim 1, wherein each of the plurality of identified advertisements are about the same product and present the product containing different informational content.

9. The method of claim 8, wherein informational content describes the product in a manner that targets a different state of mind of the user.

10. A method of matching an advertisement to a user engaging an interface, comprising:
identifying a plurality of advertisements;
obtaining a source ambient factor, wherein the source ambient factor describes a variable condition of at least one of the user's environment and the user's body; and
selecting an advertisement from the plurality of identified advertisements to be displayed to the user via an interface, the selected advertisement having a predetermined relational association with the obtained source ambient factor.

11. The method of claim 10, wherein the source ambient factor describes a current variable condition of at least one of the user's environment and the user's body as the user engages the interface.

12. The method of claim 10, wherein the source ambient factor is an environmental ambient factor that describes a variable condition within the user's local environment.

13. The method of claim 12, wherein the variable condition described by an environmental ambient factor includes at least one of the time of day, the day of the week, ambient sun conditions, ambient weather conditions, ambient sound levels, ambient temperature conditions, ambient characteristic sounds, ambient light levels, and ambient characteristic images.

14. The method of claim 10, wherein the source ambient factor is a bodily ambient factor that describes variable conditions of the user's body.

15. The method of claim 14, wherein the variable condition described by a bodily ambient factor includes at least one of body temperature, blood pressure, body posture, and heart rate.

16. The method of claim 10, wherein each of the plurality of advertisements is relationally associated with a target ambient factor, the step of selecting an advertisement to be displayed to the user further comprising:
identifying a target ambient factor having a predetermined relationship with the source ambient factor; and
selecting an advertisement relationally associated with the identified target ambient factor to be displayed to the user.

17. The method of claim 16, wherein the source ambient factor has the predetermined relationship with the target ambient factor when the source and target ambient factors belong to the same class of ambient factors.

18. The method of claim 17, wherein the source ambient factor has the predetermined relationship with the target ambient factor when the source and target ambient factors belong to the same sub-class of ambient factors.

19. The method of claim 16, further comprising:
obtaining source ambient factor data, wherein the source ambient factor data characterizes the source ambient factor;
identifying values of the source ambient factor data;
identifying values of target ambient factor data, wherein the source ambient factor data characterizes the target ambient factor;
determining whether the value of the source ambient factor data is within a predetermined range of the value of the target ambient factor data; and
identifying the target ambient factor having a value of target ambient factor data determined to be within the predetermined range of the value of the source ambient factor data.

20. The method of claim 19, wherein the source ambient factor data binarily characterizes the source ambient factor.

21. The method of claim 19, wherein the source ambient factor data numerically characterizes the source ambient factor.

22. The method of claim 10, further comprising obtaining a plurality of source ambient factors.

23. The method of claim 22, wherein each of the plurality of advertisements is relationally associated with a plurality of target ambient factors, the step of selecting an advertisement to be displayed further comprising:
identifying a plurality of target ambient factors having a predetermined relationship with the plurality of source ambient factors; and
selecting an advertisement relationally associated with the identified plurality of target ambient factors to be displayed to the user.

24. The method of claim 10, further comprising identifying the plurality of advertisements based upon a query by the user.

25. The method of claim 10, further comprising identifying the plurality of advertisements based upon a document accessed by the user.

26. The method of claim 25, wherein the step of selecting an advertisement to be displayed to the user includes:
identifying a content topic set associated with the document accessed by the user; and
determining whether target content information for an advertisement of the plurality of advertisements has a predetermined relationship with the content topic set, wherein the target content information relates to the subject matter for which the advertisement is relevant;
selecting the advertisement having target content information determined to have the predetermined relationship with the content topic set to be displayed to the user.

27. The method of claim 26, wherein the step of determining whether the target content information has the predetermined relationship with the content topic set includes determining whether the target content information matches a content topic within the content topic set.

28. The method of claim 27, wherein the step of determining whether the target content information has the predetermined relationship with the content topic set includes determining whether the target content information matches a content topic having a predetermined ranking within the content topic set.

29. The method of claim 10, wherein the plurality of identified advertisements present the same subject matter in a plurality of styles, the step of selecting an advertisement further comprising:
identifying a style from the plurality of styles that has a predetermined relationship with the source ambient factor; and
selecting the identified style as the style by which the selected advertisement is displayed to the user.

30. The method of claim 10, further comprising:
obtaining source demographic information, wherein the source demographic information describes a demographic group to which the user belongs;
identifying target demographic information for each of the plurality of identified advertisements, wherein the target demographic information describes a demographic group for which each advertisement is relevant;
determining whether source demographic information for an advertisement has a predetermined relationship with the target demographic information; and
selecting the advertisement having target demographic information determined to have the predetermined relationship with the source demographic information to be displayed to the user.

31. An apparatus for matching an advertisement to a user engaging an interface, comprising:
means for identifying a plurality of advertisements;
means for obtaining a source ambient factor, wherein the source ambient factor describes a variable condition of at least one of the user's environment and the user's body; and
means for selecting an advertisement from the plurality of identified advertisements to be displayed to the user via an interface, the selected advertisement having a predetermined relational association with the obtained source ambient factor.

32. An apparatus for matching an advertisement to a user engaging an interface, comprising:
circuitry having executable instructions; and
at least one processor configured to execute the program instructions to perform operations of:
identifying a plurality of advertisements;
obtaining a source ambient factor, wherein the source ambient factor of at least one of the user's environment and the user's body; and
selecting an advertisement from the plurality of identified advertisements to be displayed to the user via an interface, the selected advertisement having a predetermined relational association with the obtained source ambient factor.
